(19) United States
(12) Patent Application Publication
(10) Pub. No.: US 2023/0075785 A1
(43) Pub. Date: Mar. 9, 2023

(54) ANTI-CORROSION KIT AND ANTI-CORROSION AGENT FORMED THEREFROM

(71) Applicant: Evonik Corporation, Parisppany, NJ (US)

(72) Inventors: Sheba Bergman, Glen Cove, NY (US); Jacob Shevrin, Port Washington, NY (US)

(73) Assignee: Evonik Corporation, Parsippany, NJ (US)

(21) Appl. No.: 17/760,456

(22) PCT Filed: Feb. 8, 2021
(86) PCT No.: PCT/US2021/017092

§ 371 Date: Aug. 10, 2022

Related U.S. Application Data
(60) Provisional application No. 62/704,953, filed on Jun. 4, 2020.
(60) Provisional application No. 62/976,369, filed on Feb. 14, 2020.

(51) Int. Cl. C09D 5/08; C09D 183/08

(52) U.S. Cl. CPC C09D 5/082; C09D 183/08

(57) ABSTRACT

An anti-corrosion agent can be prepared from a kit-of-parts. The kit-of-parts contains at least one silica sol based composition and at least one aminoalkyl functional siloxane compound. A method can be used for preparing the anti-corrosion agent. An anti-corrosion layer can be prepared with the anti-corrosion agent, and a method can be used for providing the layer.

The present invention relates to a kit-of-parts for preparing an anti-corrosion agent, a method for preparing said anti-corrosion agent, said anti-corrosion agent, a method for forming an anti-corrosion layer, an anti-corrosion layer and an article comprising said anti-corrosion layer.

### BACKGROUND OF THE INVENTION

Corrosion is by far one of the most damaging and costly natural phenomena mankind faces across the globe, significantly impacting the aerospace, automotive, construction, and electronic industries year after year. While there are many different methods to protecting metals from corrosion, chromate treatment has been one of the most well-established, inexpensive methods used across the globe over the past several decades. Although the performance, efficiency, and affordability of chromate treatment has benefited the corrosion protection industry for years now, governmental regulations and public awareness of the hazards associated with chromate treatment has never been higher.

Since 2013, hexavalent chromium has been classified as a carcinogen and mutagen by the European Union. Furthermore, Europe's Registration, Evaluation, Authorization, & Restriction of Chemicals (REACH) regulations have restricted the use of hexavalent chromium in almost every industry across Europe. Due to potentially serious consequences of corrosion-related structural failure and the long qualification periods required for new aerospace-related products, the topic of environmentally-friendly corrosion protection alternatives has been a major interest to manufacturers, governments, and raw material suppliers of the aerospace industry over the past several years.

One viable alternative to these hazardous corrosion protection technologies is organofunctional silane technology. The mechanism of corrosion protection from organofunctional silane pretreatments is best described by the ability of the highly crosslinked silicon-based network to act as a barrier when applied on a metal surface. One severe drawback of organofunctional alkoxysilanes is the generation of high amounts of volatile organic constituents (VOCs) during the metal pretreatment application. This is one of the reasons organofunctional silanes have not been yet established as corrosion protection systems.

Another drawback of the known organofunctional silane technology is the relatively high curing temperature which is required to yield an anti-corrosion effect. This, however, limits the technology's applicability and is ecologically unsound.

US 2009/022898 A1 and US 2010/159144 A1 both disclose water-borne silica sol compounds and their uses as corrosion inhibitors. However, the inventors of the present invention found that the anti-corrosion effects of said silica sol compounds are insufficient, failing for example to meet typical industry standard test. Such a typical industry standard to assess the anti-corrosion effect is the neutral salt spray test (NSS test). It is of paramount interest in the industry that any new anti-corrosion agent meets the requirements of at least the NSS test according to ASTM B117 (2019).

### OBJECTIVE OF THE INVENTION

It is therefore the objective of the present invention to overcome the shortcomings of the prior art.

It is an objective of the present invention to provide a chromate-free anti-corrosion agent based on the silane technology.

It is a further objective of the present invention to provide for an anti-corrosion agent which allows for an improved anti-corrosion effect to be achieved compared to the state of the art, especially to the corrosion inhibitors based on the silane technology known to date.

It is another objective of the present invention to provide an ecologically more benign anti-corrosion agent than those of the prior art while still meeting the industry demands for the desired anti-corrosion effect, i.e. the neutral salt spray test according to ASTM B117 (2019).

### SUMMARY OF THE INVENTION

These objectives are solved by the kit-of-parts according to the invention for preparing an anti-corrosion agent comprising

A) at least one silica sol based composition comprising at least a reaction product of at least the following components
A.1) at least one glycidyloxypropylalkoxysilane;
A.2) at least one aqueous silica sol;
A.3) at least one organic acid; and
A.4) at least one metal compound wherein the metal is a member of group 4 of the period table of elements according to the IUPAC nomenclature; and

B) at least one aminoalkyl functional siloxane compound and by using the kit-of-parts according to the invention to prepare the anti-corrosion agent according to the invention.

The objectives are further solved by the anti-corrosion agent according to the invention obtainable by a reaction of at least the reaction product of at least the following components

A.1) at least one glycidyloxypropylalkoxysilane;

A.2) at least one aqueous silica sol;

A.3) at least one organic acid; and

A.4) at least one metal compound wherein the metal is a member of group 4 of the period table of elements according to the IUPAC nomenclature; and

B) at least one aminoalkyl functional siloxane compound.

The objectives are also solved by the method for forming at least one anti-corrosion layer according to the invention comprising the method steps

L1) providing a substrate having at least one metallic surface;

L2) optionally, pretreating the at least one metallic surface; and

L3) contacting the metallic surface of the substrate with the anti-corrosion agent according to the invention,

such that an anti-corrosion layer is formed on the metallic surface of the substrate.

Advantageously, using the anti-corrosion agent according to the invention significantly decreases the amount of VOCs compared to the usage of standard silanes.

The present invention further advantageously allows for anti-corrosion layers to be obtained which are very resistant to alkaline environments such as alkaline solutions.

A further beneficial effect of the anti-corrosion layers of the present invention is their high stability against water and especially against water at elevated temperatures.

Surprisingly, the anti-corrosion agent according to the invention can be cured at a very low temperature compared to other standard silanes and to known corrosion inhibitors based on the silane technology while still allowing for an improved anti-corrosion effect to be achieved.

Preferred embodiments of the present invention which were found to work the invention particularly well are described in the appended description and in the dependent claims.

### BRIEF DESCRIPTION OF THE FIGURES

FIG. 1 shows a Bode plot of the absolute impedance (Z) of several pretreated aluminum 2024T3 substrates over a wide frequency range (see Examples).

### DETAILED DESCRIPTION OF THE INVENTION

Percentages throughout this specification are weight-percentages (weight-%) unless stated otherwise. Yields are given as percentage of the theoretical yield. Concentrations given in this specification refer to the volume or mass of the entire solutions or dispersions unless stated otherwise.

The term “alky” according to the present invention comprises branched or unbranched alkyl groups comprising cyclic and/or non-cyclic structural elements, wherein cyclic structural elements of the alkyl groups naturally require at least three carbon atoms. C1-CX-alkyl in this specification and in the claims refers to alkyl groups having 1 to X carbon atoms (X being an integer). C1-C8-alkyl for example includes, among others, methyl, ethyl, n-propyl, iso-propyl, n-butyl, isobutyl, sec-butyl, tert-butyl, n-pentyl, iso-pentyl, sec-pentyl, tert-pentyl, neo-pentyl, hexyl, heptyl and octyl. The term “alkanediyl” is the corresponding group having two free valences (bonding sites). Sometimes, it is referred to as “alkylene” in the art. Said residues according to the present invention comprise cyclic and/or non-cyclic structural elements and can be linear and/or branched. C1-C4-alkanediyl for example includes, among others, methane-1,1-diyl, ethane-1,2-diyl, ethane-1,1-diyl, propane-1,3-diyl, propane-1,2-diyl, propane-1,1-diyl, butane-1,4-diyl, butane-1,3-diyl, butane-1,2-diyl, butane-1,1-diyl, butane-2,3-diyl. Furthermore, individual hydrogen atoms bound to the alkanediyl compound may in each case be substituted by a functional group such as those defined above for the alkyl group. Unless stated otherwise, alkanediyl groups are preferably selected from substituted or unsubstituted C1-C8-alkanediyl, more preferably from substituted or unsubstituted C1-C4-alkanediyl because of their improved water-solubility.

The term “ary” according to the invention refers to ring-shaped aromatic hydrocarbon residues, for example phenyl or naphtyl where individual ring carbon atoms can be replaced by N, O and/or S, for example benzothiazolyl. Preferably, no carbon atoms are substituted to avoid undesired side-reactions in the preparation of the pyridinium compounds. Furthermore, aryl groups are optionally substituted by replacing a hydrogen atom in each case by a functional group. The term C5-CX-aryl refers to aryl groups having 5 to X carbon atoms (optionally replaced by N, O and/or S) in the ring-shaped aromatic group (X naturally being an integer). C5-C6-aryl is preferred unless stated otherwise.

Unless stated otherwise, above-described groups are substituted or unsubstituted, preferably unsubstituted. Functional groups—if present—as substituents are preferably hydroxyl (—OH) groups to improve the water-solubility of the respective compounds.

If more than one residue is to be selected from a given group, each of the residues is selected independently from each other unless stated otherwise hereinafter, meaning they can be selected to be the same members or different members of said group. The bonding sites in some chemical formulae herein may be emphasized by a wavy line ( [symbol] ). The terms “alkoxy” and “oxyalkyl” are used interchangeably herein.

Temperatures are measured at 1013 mbar unless stated otherwise. Standard conditions are 25° C. and 1013 mbar. Details and preferences described for one aspect of the present invention apply mutatis mutandis to the other aspects thereof and are not cited again to avoid unnecessary repetitions. The methods according to the invention optionally comprise further method steps to be included in said methods before, after or between the named method steps. Typically, unless stated otherwise, the method steps are carried out in the given order.

The kit-of-parts according to the invention is suitable for preparing an anti-corrosion agent. The kit-of-parts according to the invention comprises at least two parts: part A) and part B).

Part A) comprises at least one silica sol based composition comprising at least a reaction product of at least the following components

A.1) at least one glycidyloxypropylalkoxysilane;

A.2) at least one aqueous silica sol;

A.3) at least one organic acid; and

A.4) at least one metal compound wherein the metal is a member of group 4 of the period table of elements according to the IUPAC nomenclature.

Component A.1) is preferably selected from the group consisting of 3-glycidyloxypropyltrimethoxysilane, 3-glycidyloxypropyltriethoxysilane, 3-glycidyloxypropylmethyldimethoxysilane, 3-glycidyloxypropylmethyldiethoxysilane or a mixture of the aforementioned silanes.

Component A.2) is at least one aqueous silica sol. Preference is given as component A.2) to a usually cationic, colloidally disperse silica sol having a solids content of >1 to ≤50 weight-%, with very particular preference of 30 to <50 weight-%, in particular of 40 to <50 weight-%, i.e. around 45 weight-%. The balance to 100 weight-% is preferably water. Preferred aqueous silica sols have in particular a pH value of 3 to 5, in particular of 3.5 to 4. It is also possible, however, to use alkaline or neutrally stabilized silica sol. Furthermore, preferred silica sols generally contain amorphous, aqueous silica oxide particles having an average particle size (d₅₀) of 40 to 400 nm, examples—but not exclusively—being Levasil® 200S/30% and Levasil® 100S/45%. The particle size distribution can be determined in conventional manner by means of laser diffraction (Coulter LS particle size measuring instrument in accordance with ISO 13320:2020).

Component A.3) is at least one organic acid. Any organic acid can be used within the scope of the present invention. Preferably, the at least one acid is selected from the group consisting of acetic acid, propionic acid and maleic acid. The amount of the at least one acid in the silica sol based composition preferably ranges from 0.01 to 3 weight-%, more preferably from 0.5 to 2 weight-%, in particular from 1 to 2 weight-%, based on the silica sol based composition.

Component A.4) is at least one metal compound wherein the metal is a member of group 4 of the period table of elements according to the IUPAC nomenclature. Said group 4 of the period table of elements according to the IUPAC nomenclature consists of titanium, zirconium and hafnium. Titanium compounds and zirconium compounds are preferred. Preferred metal compounds are selected from the group consisting of alkoxides and acetylacetonates as they generally react quickly and completely in the formation of the desired reaction product. More preferred are zirconium alkoxides, zirconium acetylacetonates, titanium alkoxides, titanium acetylacetonates and mixtures of the aforementioned. Even more preferred are zirconium C1-C4-alkoxides, zirconium acetylacetonates, titanium C1-C4-alkoxides, titanium acetylacetonates and mixtures of the aforementioned. Most preferred are zirconium tetra-n-propoxide (Zr(O—CH₂—CH₂—CH₃)₄), titanium acetylacetonate (Ti(acac)₂) and titanium tetra-n-butoxide (Ti(O—CH₂—CH₂—CH₂—CH₃)₄) for the reasons described above. Component A.4) is preferably employed in an amount ranging 0.5 to 8.0 weight-%.

Preferably, the mass ratio of the solids mass of component A.2) to component A.1) preferably is ≤0.75. Preference is given here to a mass ratio of the solids mass of component A.2) to component A.1) of 0.1 to 0.7, more preferably of 0.2 to 0.6, in particular of 0.3 to 0.5. This improves the stability of the silica sol based composition as well as the pot life of the anti-corrosion agent. Preferably, the reaction product is formed by the reaction of components A.1), A.2), A.3) and A.4). Furthermore, the silica sol based composition is preferably substantially free from chloride, i.e. containing preferably less than 0.8 weight-%, in particular less than 0.5 weight-%, of chloride, based on the composition. Halides occasionally deteriorate the anti-corrosion effect and thus their omission further improves the anti-corrosion effect of the present invention.

The silica sol based composition according to the invention is generally a slightly turbid to opalescent fluid. The particles in the silica sol based composition preferably have an average diameter (d₅₀) of 40 to 200 nm, more preferably of 50 to 100 nm.

The storage stability can be additionally prolonged by the addition of a particularly suitable organic solvent, e.g. ≤10 weight-% of 1-methoxypropan-2-ol. Thus, the silica sol based composition according to the invention may advantageously have a 1-methoxypropan-2-ol content of ≤10 weight-%, preferably 5 to 10 weight-%, based on the total composition. The silica sol based composition according to the invention have a water content of preferably around 99.5% to 30 weight-%, more preferably of 90% to 40 weight-%, very preferably of 80% to 50 weight-%, based on the total composition.

Preferably, the silica sol based composition according to the invention has a solids content ranging from 0.5 to 60 weight-%, more preferably from 5 to 55 weight-%, even more preferably from 10 to 50 weight-%, still even more preferably from 20 to 40 weight-%, in particular from 25 to 35 weight-%, based on the total composition.

In addition it is possible to modify the solids content and the viscosity of the silica sol based composition by adding water. Advantageously in this context the amount of water added is such as to give a solids content in above ranges.

Furthermore, the silica sol based composition according to the invention are notable for a comparatively low hydrolysis alcohol content of 5 weight-% or less, preferably 3 weight-% or less, more preferably 1 weight-% or less, based on the total composition. The alcohol content of the silica sol based composition of the invention can be determined in conventional manner by means of gas chromatography, for example as described in US 2011/0268899 A1 (see especially paragraphs 192-198).

Optionally, the silica sol based composition according to the invention further comprises at least one surfactant. In particular it is possible in this way, through the addition of a silicone surfactant, for example BYK-348 (polyether-modified polydimethylsiloxane), to achieve an additional improvement in the substrate wetting, which can make an advantageous contribution to avoiding flow problems in association with the production of coatings, particularly on metallic substrates. Preference is given in general to a surfactant content of <0.5 weight-%, in particular of 0.1% to 0.3 weight-%, based on the composition.

The silica sol based composition preferably consists of the reaction product of at least the following components

A.1) at least one glycidyloxypropylalkoxysilane;

A.2) at least one aqueous silica sol;

A.3) at least one organic acid; and

A.4) at least one metal compound wherein the metal is a member of group 4 of the period table of elements according to the IUPAC nomenclature;

water;

optionally, at least one organic solvent; and

optionally, at least one surfactant.

The silica sol based composition, especially a water-diluted variant thereof, has a pH value of preferably 4 to 9, in particular of 4.5 to 8, resulting in an enhanced storage stability. The pH value can be determined in conventional manner, by means for example of pH paper, pH sticks and pH electrodes.

The silica sol based composition according to the invention are obtainable by initially introducing component A.1), subsequently metering in component A.3) with effective commixing, then adding component A.2), thereafter adding component A.2), and causing a reaction to take place, the reaction being carried out if desired with the addition of at least one diluent, and preferably starting from a mass ratio of the solids mass of component A.2) to component A.1)≤0.75.

Diluents which can be used in the present process include water, methanol, ethanol and/or 1-methoxypropan-2-ol and also further alcohols, such as propanol or isopropanol, for example.

The reaction is carried out preferably at a temperature of 0 to 35° C., more preferably at 5 to 25° C., for a period of 1 to 60 minutes, more preferably over 5 to 20 minutes, and the resulting product mixture is allowed to react further appropriately at a temperature of around 35 to 85° C., preferably at 50 to 60 or 60 to 70° C., i.e. preferably somewhat below the boiling point of the hydrolysis alcohol, for 10 minutes to 4 hours, more preferably for 30 minutes to 3 hours. Reaction and the subsequent further reaction are generally carried out with effective commixing, such as with stirring, for example.

Subsequently, it is possible to remove the hydrolysis alcohol formed in the reaction, particularly methanol, ethanol and/or n-propanol, from the resulting product mixture system by distillation, preferably under reduced pressure, and, if desired, to replace the amount of alcohol removed by a corresponding amount of water. Thereby, the reaction product of the silica sol based composition is formed.

An additional possibility is to add a surfactant to the reaction mixture or to the product mixture, for example—but not exclusively—BYK 348.

An alternative option is to dilute the resulting product mixture, and/or to set the desired solids content, where possible, using water and/or 1-methoxypropan-2-ol or other alcohols.

Part B) of the kit-of-parts according to the invention comprises or consists of the at least one aminoalkyl functional siloxane compound.

The at least one aminoalkyl functional siloxane compound comprises siloxane building blocks comprising aminoalkyl groups and alkyl groups. The aminoalkyl groups and the alkyl groups in this context are bound to the silicon atoms forming the siloxane building blocks.

Preferably, the at least one aminoalkyl functional siloxane compound comprises at least one molecular unit according to formula (B1)

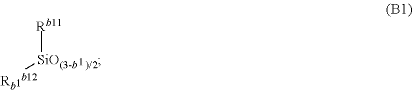

wherein
R^{b11} is a C1-C18-alkyl group;
each R^{b12} is independently an oxyalkyl group;
b¹ is selected from 0, 1 and 2;

and

at least one molecular unit according to formula (B2)

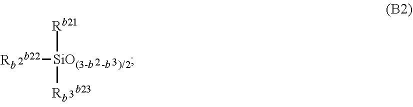

wherein
R^{b21} is an aminoalkyl functional group;
R^{b22} is C1-C8-alkyl group, preferably a C1-C4-alkyl group, more selected from methyl group and ethyl group;
each R^{b23} is independently an oxyalkyl group;
b² is selected from 0 and 1; and
b³ is selected from 0, 1 and 2;
with the proviso that the sum of b² and b³ is 0, 1 or 2.

R^{b11} is preferably a C2-C8-alkyl group, more preferably a C2-C4-alkyl group. R^{b12} is preferably an oxy-C1-C4-alkyl group, more preferably selected from methoxy group and ethoxy group.

The aminoalkyl functional group (of R^{b21}) is an alkyl group functionalized by at least one amino group wherein the at least one amino group is a primary, secondary or tertiary amino group and wherein said alkyl group is optionally interrupted by one or more amino groups, thus one or more amino groups are optionally placed in-between two of the carbon atoms forming the alkyl group.

R^{b21} is preferably a

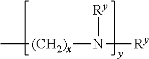

group
wherein each x is independently an integer ranging from 1 to 6, preferably 2 or 3;
y is an integer selected from 1, 2 and 3, preferably 2 or 3;
each R^{y} is independently selected from the group consisting of hydrogen, alkyl group and aryl group, preferably selected from hydrogen and C1-C4-alkyl group, more preferably hydrogen.

Even more preferably R^{b21} is

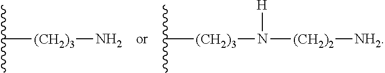

b² is preferably 0. Above preferences result in an aminoalkyl functional siloxane compound giving particularly good anti-corrosion effects in the context of the present invention.

Preferably, the aminoalkyl functional siloxane compound comprises 2 to 30, more preferably 3 to 20, even more preferably 4 to 15, molecular units according to formulae (B1) and (B2). Preferably, the aminoalkyl functional siloxane compound consists of molecular units according to formulae (B1) and (B2). The number of molecular units according to formulae (B1) and (B2) can be measured by routine techniques such as gel permeation chromatography (e.g. with a polystyrene standard and a mixed bed column) or preferably by NMR, especially by ²⁹Si-NMR. The latter allows to distinguish between the M, D, T-units and thus allows to calculate the molecular mass.

The aminoalkyl functional siloxane compound is usually oligomeric or polymeric. An oligomer in the context of the present invention comprises in total 2 to 4 molecular unit according to formulae (B1) and (B2) while a polymer comprises 5 or more of said molecular units in total. In total means the sum of molecular unit according to formula (B1) and molecular unit according to formula (B2).

There is at least one chemical bond between at least one molecular unit according to formula (B1) and at least one molecular unit according to formula (B2), i.e. the two respective silicon atoms of the molecular units are bonded to each other via a bridging oxygen atom. Such chemical bond (including one of the molecular units each) can exemplarily be depicted as follows:

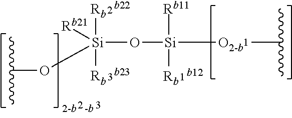

Preferably, the at least one aminoalkyl functional siloxane compound has an alkoxy group content (corresponds to R^{b12} and R^{b23} in above chemical formulae) ranging from 0.1 to 50 weight-%, more preferably from 1 to 30 weight-%, even more preferably from 2 to 25 weight-%, still even more preferably from 3 to 10 weight-%, based on the aminoalkyl functional siloxane compound. These ranges include all specific values and subranges therebetween, such as 0.2, 0.5, 1, 2, 8, 10, 15 and 20 weight-%. Said amounts of the alkoxy groups in the aminoalkyl functional siloxane allow for a faster reaction of the aminoalkyl functional siloxane with the reaction product present in part A) of the kit-of-parts according to the invention and additionally, better anti-corrosion effects are achievable while the amount of VOC is still very low. The amount of the alkoxy group content can be measured by ¹H-NMR or alternatively, albeit less preferably, by total hydrolysis, e.g. with an alkaline aqueous solution (such as NaOH in water) followed by gas chromatography of the formed alcohol.

Preferably, the at least one aminoalkyl functional siloxane compound is free of fluorine atoms. Although fluorinated side-groups in silanes and siloxanes tend to improve the hydrophobicity of a film formed of such silanes or siloxanes, they might have a severe impact on the environment and are thus preferably not used.

Preferably, the at least one aminoalkyl functional siloxane compound does not comprise any dialkylsiloxane groups, in particular the at least one aminoalkyl functional siloxane compound does not comprise any dimethylsiloxane groups (Si(Me)₂O_{2/2}).

Preferably, the at least one aminoalkyl functional siloxane compound is a block-oligomer or block-polymer. It was found much to the surprise of the inventors that using such block-oligomers or block-polymers resulted in a considerably improved anti-corrosion effect. It is therefore particularly preferred that the aminoalkyl functional siloxane compound is a block-oligomer or a block-polymer and comprises or consists of at least one molecular unit according formula (B1) and at least one molecular formula according to formula (B2).

Preferably, the aminoalkyl functional siloxane compound comprises halides in a concentration of 5 weight-% or less, more preferably in a concentration of 1 weight-% or less, even more preferably in a concentration of 0.1 weight-%, still even more preferably in a concentration of 0.01 weight-%. Most preferably the aminoalkyl functional siloxane compound is free of halides for the same reasons stated above.

Preferably, the ratio of the total number of molecular units according to formula (B1) to the number of molecular units according to formula (B2) ranges from 0.1 to 0.9, preferably from 0.2 to 0.8, more preferably from 0.3 to 0.7, even more preferably from 0.4 to 0.6. These ratios improve the anti-corrosion effect.

Exemplarily, the at least one aminoalkyl functional siloxane compound is obtainable by a reaction of at least the following components

H.1) at least one alkyl-functional silane;

H.2) at least one amino-functional silane;

H.3) water; and

H.4) optionally, at least one catalyst.

The reaction is preferably carried out in at least one diluent to avoid undesired precipitation or gelation during the course of the reaction. Suitable diluents are generally polar solvents, in particular C1-C4-alcohols such as methanol, ethanol, iso-propanol or and mixtures of the aforementioned. It is most preferred to use the one or more alcohols as diluent which are liberated during the hydrolysis of the silanes easing the work-up of the reaction.

Preferably, the at least one alkyl-functional silane is an alkyl-functional silane according to formula (H1)

(R^{h11}O)₃—Si—R^{h12} (H1)

wherein

each R^{h11} is independently an alkyl group; and

R^{h12} is a C1-C18-alkyl group, preferably a C2-C8-alkyl group, more preferably a C2-C4-alkyl group.

R^{h11} is preferably selected to be a C1-C4-alkyl group, more preferably selected from methyl group and ethyl group.

Preferably, the at least one amino-functional silane is an amino-functional silane according to formula (H2)

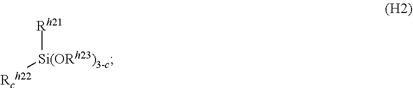

wherein

R^{h21} is an aminoalkyl functional group, preferably a molecular unit according to formula (H3)

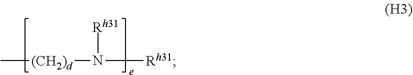

with
each R^{h31} being independently selected from the group consisting of hydrogen, alkyl group and aryl group;
d being an integer ranging from 1 to 6, preferably d is 2 or 3;
e being an integer selected from 1, 2 and 3, preferably e is 2 or 3;

R^{h22} is a C1-C8-alkyl group, preferably a C1-C4-alkyl group, more preferably selected from methyl group and ethyl group;

each R^{h23} is independently an alkyl group; and

and c is selected from 0 and 1.

Even more preferably R^{h21} is

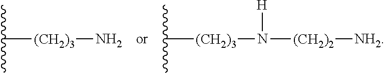

c is preferably 0.

Exemplarily, the at least one alkyl-functional silane is selected from the group consisting of methyl-trialkoxysilane, ethyltrialkoxysilane, n-propyltrialkoxysilane, isobutyltrialkoxysilane, isobutytrial-koxysilane, n-octyltrialkoxysilane, isooctyltrialkoxysilane, hexadecyltrialkoxysilane and mixtures of the aforementioned.

Exemplarily, the at least one amino-functional silane is selected from the group consisting of 3-aminopropyltrialkoxysilane, N-aminoethyl-3-aminopropytrialkoxy silane, N-aminoethyl-N-aminoethyl-3-aminopropyltrialkoxysilane, N-methylaminopropyl-trialkoxysilane, N-n-butylaminopropytrial-koxysilane, N-cyclohexylamino-propyltrialkoxysilane, N-phenyl-aminopropyltrialkoxysilane, 3-aminopropyl-methyldialkoxysilane, N-aminoethyl-3-aminopropyl-methydidalkoxysilane, N-aminoethyl-N-aminoethyl-3-aminopropyl-methyldialkoxysilane, N-methyl-aminopropyl-methyldialkoxysilane, N-n-butyl-aminopropylmethyldialkoxysilane, N-cyclohexyl-aminopropylmethyldialkoxysilane, N-phenyl-aminopropyl-methyldialkoxysilane and mixtures of the aforementioned.

Preferably, the ratio of the amount of substance of the at least one alkyl-functional silane to the amount of substance of the at least one amino-functional silane ranges from 0.1 to 0.9, preferably from 0.2 to 0.8, more preferably from 0.3 to 0.7, even more preferably from 0.4 to 0.6. By selecting above ratios concerning the amount of substance of the individual components aminoalkyl functional siloxane compound can be prepared which give particularly good anti-corrosion agents.

Preferably, the ratio of the total amount of substance of all alkyl-functional silanes and all amino-functional silanes to the amount of substance of water ranges from 1 to 10, more preferably from 2 to 5, even more preferably from 3 to 4. This gives an oligomeric or polymeric aminoalkyl functional siloxane compound having an amount of alkoxy groups content in the compound in above-defined ranges.

A suitable catalyst is an acid, preferably an organic acid. For example, acids described for A.3) can be advantageously used.

Preferably, the aminoalkyl functional siloxane compound is formed by first reacting the at least one alkyl-functional silane with the water forming an intermediate; and then reacting the intermediate with the at least one amino-functional silane such that the aminoalkyl functional siloxane compound is formed. Thereby, a block-oligomer or a block-polymer is formed. Alternatively, the order of the silanes is reversed.

In the reaction to obtain the at least one aminoalkyl functional siloxane compound, hydrolysis and condensation of the named silanes are conducted preferably under atmospheric pressure at a temperature from 10 to 95° C., with particular preference at from 60 to 80° C. The reaction is normally conducted under atmospheric pressure, although it may also be conducted under reduced pressure or under superatmospheric pressure. It is appropriate to allow the reaction mixture to react for from 2 to 8 hours before beginning the distillation workup of the product mixture.

Following optional distillative workup, the at least one aminoalkyl functional siloxane compound according to the invention contains preferably less than 5 weight-% of the used silanes and, in particular, less than 1 weight-% of free alcohols.

Preferably, the mass ratio of the silica sol based composition to the at least one aminoalkyl functional siloxane compound, based on the respective solids contents, ranges from 1 to 10, more preferably from 1.25 to 8, even more preferably from 1.5 to 6, yet even more preferably from 2 to 4. The anti-corrosion effects are enhanced by using said components in the defined ratios.

It is preferred that the kit-of-parts according to the invention does not comprise any chromium compounds and it is particularly free of hexavalent chromium salts. The same applies mutatis mutandis to the anti-corrosion agent.

The kit-of-parts according to the invention (and its individual parts) has a very long life time and can be stored for a long period of time without losing any of its beneficial aspects. Contrary to that, the anti-corrosion agent has a limited life-time and should normally be used within 1 day, preferably within 12 hours or less, ideally within 8 hours or less to avoid the loss of the anti-corrosion effect due to gelation of the anti-corrosion agent or the like.

In a further aspect, the present invention concerns a method for preparing the anti-corrosion agent according to the invention comprising the method steps

M1) providing a silica sol based composition comprising at least a reaction product of at least the following components

A.1) at least one glycidyloxypropylalkoxysilane;

A.2) at least one aqueous silica sol;

A.3) at least one organic acid; and

A.4) at least one metal compound wherein the metal is a member of group 4 of the period table of elements according to the IUPAC nomenclature; and

M2) providing at least one aminoalkyl functional siloxane compound; and

M3) mixing the silica sol based composition and the at least one aminoalkyl functional siloxane compound,

such that the anti-corrosion agent is formed.

The method steps M1) and M2) may be employed in any order. Generally, in method step M1) part A) of the inventive kit-of-parts is employed while in method step M2) part B) of the inventive kit-of-parts is used. Thus, by using the kit-of-parts according to the invention method steps M1) and M2) can be carried out.

During method step M3) a reaction of the silica sol based composition and the at least one aminoalkyl functional siloxane compound takes place yielding the anti-corrosion agent. Although the inventors have made every effort to analyze the structure of the anti-corrosion agent, it proved impossible so far to fully understand its molecular structure due to its complexity.

Preferably, the mass ratio of the silica sol based composition to the at least one aminoalkyl functional siloxane compound (to be used in the mixing, i.e. in method step M3), based on the respective solids contents, ranges from 1 to 10, more preferably from 1.25 to 8, even more preferably from 1.5 to 6, yet even more preferably from 2 to 4.

Preferably, the silica sol based composition and the at least one aminoalkyl functional siloxane compound are mixed in method step M3) for a duration of 5 to 120 min, preferably 10 to 90 min, more preferably 20 to 40 min. It was found by the inventors that in some instances a too short duration did not yield the beneficial anti-corrosion effects of the present invention. Longer mixing durations are, however, not necessary and considering the limited pot life of the anti-corrosion agent according to the invention should be avoided. During mixing, it is preferred that the mixing is accompanied by stirring or the like so that the individual components are well commixed.

Preferably, the mixing of the silica sol based composition and the at least one aminoalkyl functional siloxane compound is performed at a temperature ranging from 5 to 50° C., preferably from 10 to 40° C., more preferably from 15 to 30° C.

Preferably, the method comprises a further method step:

M4) adding at least one solvent to one or more of the silica sol based composition, the at least one aminoalkyl functional siloxane compound, the mixture of the aforementioned or the anti-corrosion agent.

By adding the at least one solvent, the solids content of the anti-corrosion agent is set to a desired value. Preferable solvents are selected from the group consisting of water and alcohols such as 1-methoxypropan-2-ol, methanol, ethanol as well as iso-propanol and mixtures of the aforementioned. Water is particularly preferably used as the (only) solvent due to its ecologically benign character. Method step M4) is optionally included in the method at any time. It is also possible to first provide the at least one solvent and then carry out method steps M1) to M3).

Optionally, the pH value of the anti-corrosion agent is set to slightly acidic to alkaline. Any pH adjusters such as acids, bases or buffers may be used to adjust the pH value of the anti-corrosion agent. Preference is given to organic acids as acids, in particular to those listed above for A.3). Preferred bases are for example alkaline hydroxides (NaOH, KOH) or ammonia. The pH value of the anti-corrosion agent preferably ranges from 6 to 12, more preferably from 7 to 10, even more preferably from 8 to 9. Theses ranges eliminate the risk of involuntarily damaging the substrate or the at least one metallic surface to be treated and give a sufficiently long pot-life of the anti-corrosion agent for it to be used, e.g. in the method for forming at least one anti-corrosion layer according to the invention.

The anti-corrosion agent according to the invention is obtainable by a reaction of at least the reaction product of at least the following components

A.1) at least one glycidyloxypropylalkoxysilane;

A.2) at least one aqueous silica sol;

A.3) at least one organic acid; and

A.4) at least one metal compound wherein the metal is a member of group 4 of the period table of elements according to the IUPAC nomenclature; and

B) at least one aminoalkyl functional siloxane compound.

The named components correspond to the parts of the kit-of-parts according to the invention. The inventive kit-of-parts can thus be used to prepare the anti-corrosion agent according to the invention.

Preferably, the anti-corrosion agent has a slightly acidic to alkaline pH value, preferably ranging from 6 to 12, more preferably from 7 to 10, even more preferably from 8 to 9 for the reasons laid out above.

Preferably, the anti-corrosion agent further comprises at least one solvent, preferably one selected from the group defined above (see method step M4).

The anti-corrosion agent preferably has a solids content ranging from 1 to 25 weight-%, more preferably from 3 to 20 weight-%, even more preferably from 5 to 15 weight-%. The solids content ranges allow for an improved pot life of the anti-corrosion agent according to the invention.

Preferably, the anti-corrosion agent consists of the product of the above-cited reaction and optionally, the at least one solvent.

The method for forming at least one anti-corrosion layer according to the invention comprises the method steps L1) to L3) as defined above.

In method step L1), the substrate having the at least one metallic surface is provided. Preferably, the metallic surface comprises at least one material selected from the group consisting of copper, magnesium, aluminum, iron, mixtures and alloys of the aforementioned. More preferably, the metallic surface is (essentially) made of one or more of magnesium, magnesium alloy, aluminum, aluminum alloy, copper, copper alloy, iron or iron alloy. This is to say that at least 90 weight-%, preferably 99 weight-%, of the surface is made of the named material. Particular preference is given sur-faces made of one of the following alloys: 2024T3 (copper-aluminium alloy), 6061 TB (copper-aluminium alloy), stainless steel, galvanized steel, hot dip galvanized steel, galvalume, Mg AZ31B and cold rolled steel.

In optional method step L2) the at least one metallic surface is pre-treated. Typical pretreatments include cleaning and degreasing of the at least one metallic surface. Cleaning may take place for example—but not exclusively—by chemical, mechanical or thermal means. Chemical cleaning includes the treatment of the at least one metallic surface with at least one solvent, with an aqueous solution comprising a wetting agent and/or with an (aqueous) alkaline or acidic solution optionally comprising an oxidizing agent. Preferably, the pretreatment in method step L2) comprises at least one cleaning step.

In method step L3) the at least one metallic surface of the substrate is contacted with the anti-corrosion agent according to the invention. It is possible within the means of the present invention to contact the entire surface or only a part thereof. Such contact is typically established by brushing, squirting, spraying, knife coating or dipping, for example, to name but a few possibilities.

The duration of the contact between the at least one metallic surface and the anti-corrosion agent according to the invention preferably ranges from 1 to 600 seconds, preferably from 10 to 300 seconds, more preferably from 30 to 120 seconds. A too short duration occasionally does not result in enough anti-corrosion agent to be present on the at least one metallic surface while longer durations do not provide any further advantage but only adds to the cost.

Preference is given to aiming for layer thicknesses of 0.1 to 10 μm, with particular preference being given to layer thicknesses of 0.2 to 2 μm. Such layer thicknesses give a sufficient anti-corrosion effect without adding to much to the cost of an article comprising such layer. The layer thickness obtained depends inter alia on the solids content of the anti-corrosion agent and the duration of the contact.

Preferably, the method comprises a further method step after method step L3):

L4) drying the anti-corrosion layer.

It is preferred to dry the anti-corrosion layer after method step L3).

The drying preferably takes place at a temperature ranging from 20 to 30° C. or at room temperature (20 to 25° C.) for a time necessary to obtain layer firm to the touch. Usually the drying ranges from 0.5 min to 48 hours, more preferably from 1 to 38 hours, in particular 4 to 24 hours.

Optionally, the method comprises a further method step, preferably included in the method after method step L4):

L5) curing the anti-corrosion layer.

The anti-corrosion layer is optionally cured. This curing takes place at elevated temperature, e.g. 50° C. or more. The temperature in method step L5) preferably ranges from 100 to 400° C., more preferably from 150 to 250° C., even more preferably at 180 to 220° C. The time for the completion of the curing may vary between a few seconds, days and weeks depending on temperature, and is preferably from 0.5 to 60 minutes, more preferably from 1 to 40 minutes. Drying in method step L4) can be shortened if method step L5) is included in the method according to the invention.

Optionally, the method comprises a further method step L6):

L6) forming at least one primer layer on the anti-corrosion layer.

Optionally, the method comprises a further method step L7):

L7) forming at least one topcoat layer on the primer layer.

Optional method steps L6) and L7) are included after method step L3) and if any one of method steps L4) and L5) are included after these steps. Details for the primer layer and the topcoat layer are given below.

It is a distinct advantage of the present invention that the drying of the anti-corrosion agent can be effected at relatively low temperatures such as 20° C. Anti-corrosion layers according to the invention dried at 20 to 25° C. give almost identical results compared to layers cured at elevated temperatures. As a result the overall energy consumption of the entire method according to the invention is decisively lower compared to the solutions of the prior art allowing a particularly economic and ecological process to be obtained. The requirement of elevated temperature curing further limits the prior art solutions' applicability (compare e.g. DIY applications which often cannot be cured at elevated temperatures) which in case for the present invention is no longer an issue.

Another advantage of the anti-corrosion layers of the present invention is their higher hydrophobicity compared to many layers formed by prior art anti-corrosion solutions.

In a further aspect, the present invention concerns an anti-corrosion layer formed by contacting at least a portion of a metallic surface of a substrate with the anti-corrosion agent according to the invention.

In yet a further aspect, the present invention concerns an article comprising

S1) a substrate having at least one metallic surface; and

S2) at least one anti-corrosion layer formed by contacting the at least one metallic surface layer of the substrate with the anti-corrosion agent according to the invention;

wherein the at least one anti-corrosion layer is located (directly) on the at least one metallic layer.

Preferably, the anti-corrosion layer has a thickness ranging from 0.1 to 10 μm, with particular preference being given to layer thicknesses ranging from 0.2 to 2 μm for the reasons laid out before. Preferably, the article comprises a further layer on the at least one anti-corrosion layer-S3) at least one primer layer.

A primer layer is a preparatory coating layer that allows for better adhesion of a paint or topcoat to a surface. The primary role of a primer layer is to bond to the anti-corrosion layer, support inhibiting the corrosion of the underlying metallic surface, and provide an adhesion promotion for any subsequent topcoats.

The person skilled in the art is aware of suitable primer layers and can chose the at least one primer layer based on routine experiments. Typical primers to be give primer layers are Bonding Primer, Multi-Purpose Primer, Stain-Blocking Primer, Chrome Free Primer, High Solids Primer, Urethane Primer, Prefabrication primer, Epoxy primer, Zinc epoxy primer, Zinc silicate primer, Etching Primer, Red Oxide Primer and Zinc Chromate Primer to name but a few. Such primers are generally commercially available. Preference is given to epoxy primers (both, water-borne and solvent-borne epoxy primers) as their use results in improved corrosion resistance of such treated substrates. The epoxy primers are ideally combined with the inventive anti-corrosion layer cured at low temperatures (such as 50° C. or less or preferably at 20 to 25° C.) because the corrosion resistance, particularly on iron containing substrates such as steel substrates, is surprisingly high. Solvent-borne epoxy primers are more preferred as they allow for an even better corrosion resistance compared to water-borne epoxy primers. However, water-borne epoxy primers are preferable when the balance of ecological considerations and high corrosion resistance are equally important.

Preferably, the article comprises a further layer on the primer layer-S4) at least one top-coat layer.

A topcoat layer is a coat of paint that is applied over the underlying primer layer and provides a resinous seal for protection and aesthetic purposes. The person skilled in the art is aware of suitable top-coats and can chose the at least one top-coat layer based on routine experiments. Typical top-coats are for example Epoxy Topcoats, Polyurethane Topcoats, Polyurea Topcoats, Acrylic Top-coats, Hybrid Topcoats, Silicone Topcoats, Chrome-free Topcoats, Glossy Topcoats, Matte Top-coats, Clear Topcoats and Pigmented Topcoats. Such topcoats are generally commercially available from a multitude of suppliers.

Particularly preferably, the article comprises the following layers in the given order to be placed upon each other, preferably directly on each other:

S1) a substrate having at least one metallic surface;

S2) at least one anti-corrosion layer formed by contacting at least a portion of the metallic surface layer of the substrate with the anti-corrosion agent according to the invention;

S3) at least one primer layer; and

S4) at least one organic top-coat layer.

The invention will now be illustrated by reference to the following non-limiting examples.

### Examples

Commercial products were used as described in the technical datasheet available on the date of filing of this specification unless stated otherwise hereinafter. Further, standards were used based on the latest version thereof available at the filing of this specification unless stated otherwise. 3M™ Surface Pre-treatment AC-130-2 was provided by 3M. Said product is a 2K-formulation and the two parts were mixed in a mass ratio of 2 (zirconate containing part) to 98 (3-trimethoxysilylpropyl glycidyl ether component containing part) with an induction time of at least 30 minutes prior to use.

Dynasylan® SIVO 111, Dynasylan® AMMO and Dynasylan® GLYMO was provided by Evonik Corp. TYZOR® NPZ was obtained from Dorf Ketal B.V. Aluminum 2024T3 and Cold Rolled Steel were used as substrates having the at least one metallic surface. They were purchased from ACT Test Panels LLC. Standards were used based on the latest version available at the point of filing the present application unless stated otherwise.

Determination of Solids Content

In accordance with DIN ISO 3251, the solids content of liquids or coating materials is understood to mean the amount of nonvolatile components, the determination being carried out under well-defined conditions.

The solids content of the present coating compositions or liquid ingredients was determined as follows in a method based on DIN ISO 3251:

A disposable aluminum dish (d=about 65 mm, h=about 17 mm) was charged with approximately 1 g of sample (accuracy 1 mg) on an analytical balance. The dish was swirled briefly to distribute the product evenly within it. The dish was stored in a drying oven at about 125° C. for 1 hour. After the end of the drying procedure the dish was cooled to room temperature for 20 minutes in a desiccator and back-weighed on the analytical balance to an accuracy of 1 mg. For each experiment it was necessary to carry out at least two determinations and to report the average value.

Measurement of Dry Coat Thickness

The layer thickness was measured at 10 positions of each substrate and was used to determine the layer thickness by XRF using the XRF instrument Fischerscope XDV-SDD (Helmut Fischer GmbH, Germany). By assuming a layered structure of the deposit, the layer thickness can be calculated from such XRF data.

Alkoxy Group Content

The alkoxy group can be calculated from a 1H-NMR-spectrum. By quantifying the respective signals of the alkoxy groups and the protons in the α-position relative to the silicon atoms in the aminoalkyl functional siloxane compound, the alkoxy group can be obtained.

Average Molar Mass

The average molar mass can be calculated from a ²⁹Si-NMR-spectrum by quantifying the respective signals for M-, D- and T-units in the compound.

Preparation of Aminoalkyl Functional Siloxane Compound 1

A 2 l stirred glass reactor with reduced-pressure, metering and distillation apparatus was charged with 246 g of n-propyltrimethoxysilane (PTMO) and this initial charge was heated to 80° C. 21.6 g of water and 144.2 g of methanol were mixed and added via the metering device over the course of 30 minutes. During this addition there was no change in the temperature of the reaction mixture. After the end of addition of the water/methanol mixture, the reaction mixture was stirred at 80° C. for 2 hours. Then, at 80° C., 687 g of ethylenediaminopropyl-trimethoxysilane (DAMO) were added and the mixture was stirred for 30 minutes. Thereafter, a mixture of 43.2 g of water and 288.4 g of methanol was added over 30 minutes and the reaction mixture was stirred at 80° C. for 1 hour.

The methanol in the reaction mixture was removed by distillation, first at atmospheric pressure (about 300 g over 3 hours) and then the remainder under reduced pressure (liquid-phase temperature 70 to 90° C., pressure falling from 450 to 1 hPa) over 3 hours. This is followed by a reduced-pressure continued treatment for 1 hour at 1 hPa and a liquid-phase temperature of about 110° C. This gives 690 g of a clear yellow liquid having the following characteristics:

Free MeOH: <0.1 weight-% (by gas chromatography, measured as described in US 2011/0268899 A1, paragraphs 191-198)

Alkoxy group content: approx. 30 weight-% (measured by ¹H-NMR).

Silicon: 17.3 weight-% (measured as described in US 2011/0268899 A1, paragraphs 185-190)

Nitrogen: 10.8 weight-%

Viscosity: 208 mPa s (DIN 53 015)

Total chloride content: 88 mg/kg (ICP-MS)

Average molar mass about 1000 g/mol (calculated via ²⁹Si-NMR, measurement of the corresponding M, D and T units)

Preparation of the Silica Sol Based Composition 1

In a stirred reactor with distillation apparatus, vacuum pump Metering apparatus, liquid-phase and overhead thermometers 415.6 g of Dynasylan™ GLYMO were introduced as an initial charge and 20.6 g of acetic acid were added with stirring. Immediately thereafter 41.1 g of TYZOR® NPZ were metered in. After 5 minutes the temperature had risen by about 2 to 5° C. At that point 417.0 g of Levasil® 100S/45% (aqueous silica sol with a solids content of 45 weight-%) were stirred in over the course of 1 minute. A good stirring action was ensured. Immediately thereafter 477.3 g of DI water were added dropwise, again rapidly. When the maximum temperature (about 42° C.) was reached the opaque dispersion was stirred further at 75 to 80° C. (reflux) for 2 hours. After the dispersion had cooled to a liquid-phase temperature of about 50° C., a further 356.4 g of DI water were metered in. Subsequently the methanol was distilled off at a liquid-phase temperature of about 50 to 60° C. and an absolute pressure of about 270 mbar. At the end of the distillation the liquid-phase temperature rose to 60 to 65° C. with unchanged pressure. The overhead temperature likewise rose to >62° C. At that point only water was distilled off, and the distillation was therefore ended. After the dispersion had cooled to ≤50° C., the amount of DI water removed by distillation, which was >59.4 g, was replenished. The dispersion was stirred further for at least 2 hours. It was discharged at 20° C. The yield of the silica sol based composition 1 was quantitative.

Free MeOH: <3%

Solids content: 38 weight-%

Preparation of the Anti-Corrosion Agent According to the Invention

The anti-corrosion agents according to the invention were each formulated in 150 mL glass beak-ers using the procedure described hereinafter and the amounts as given in the subsequent table.

First, the silica sol based composition (method step M1) was dissolved in DI (deionized) water (method step M4). Then, the aminoalkyl functional siloxane compound 1 (method step M2) was added into the DI water with silica sol based composition dissolved therein and the resulting mixture and was allowed to mix for ˜20 minutes (method step M3) before application.

Generally, the anti-corrosion agents were used within an 8 hour period after preparation. Within this time frame no gelling was observed.

TABLE 1
Anti-corrosion agents according to the invention.

| | Anti-corrosion | | Anti-corrosion | |
|---|---|---|---|---|
| | agent 1 | | agent 2 | |
| DI water | 87.89 | g | 67.22 | g |
| silica sol based composition 1 | 11.11 | g | 27.78 | g |
| aminoalkyl functional | 1.00 | g | 5.00 | g |
| siloxane compound 1 | | | | |
| Total | 100.00 | g | 100.00 | g |
| pH value | 8.0 | | 8.0 | |
| Solids content | 5 | weight-% | 15 | weight-% |

### Comparative Examples

The silica sol based composition was dissolved in DI water using the amounts given in the following table. If necessary, addition of Dynasylan® SIVO 111 was used to adjust the pH value to 7 of the solution. In the case of the sol-gel coating 4, it was necessary to add Dynasylan® AMMO to adjust the pH value to 7 of the solution.

TABLE 2
Comparative sol-gel-coatings.

| | Sol-gel | | Sol-gel | | Sol-gel | | Sol-gel | |
|---|---|---|---|---|---|---|---|---|
| | coating 1 | | coating 2 | | coating 3 | | coating 4 | |
| DI water | 86.11 | g | 58.00 | | | | 87.89 | g |
| silica sol based | 13.89 | g | 41.67 | g | | | 11.11 | g |
| composition 1 | | | | | | | | |
| Dynasylan ® | | | 0.33 | g | | | | |
| SIVO 111 | | | | | | | | |
| 3M ™ Surface | | | | | 100.00 | g | | |
| Pre-treatment | | | | | | | | |
| AC-130-2 | | | | | | | | |
| Dynasylan ® | | | | | | | 1.00 | g |
| AMMO | | | | | | | | |
| Total | 100.00 | g | 100.00 | g | 100.00 | g | 100.00 | g |
| pH value | 7.0 | | 7.0 | | 4.0 | | 7.0 | |
| Solids content | 5 | weight-% | 15 | weight-% | 2.0 | weight-% | 5 | weight-% |

Metal Surface Cleaning Procedure

Before applying the anti-corrosion agents or the sol-gel coatings (hereinafter the anti-corrosion agents 1 and 2 as well as the sol-gel-coatings are summarized as “treatment solutions”), the substrates were cleaned to achieve optimal surface wetting properties. The substrates were first wiped twice with an ethyl alcohol-soaked paper towel, then dried with a compressed air gun and placed in an alkaline washing solution for approximately 3 minutes at 60° C.-65° C. This alkaline solution was prepared by adding 150 grams of Bulk Kleen 737G (obtained from Bulk Chemicals Inc.) into 10 liters of DI water and stirring for several hours. The substrates were then rinsed with DI water and finally dried with a compressed air gun.

Coating Application Procedure

After the substrates were cleaned, the treatment solutions were applied via a dip coating procedure. The metal substrates were fully immersed in the treatment solutions for 60 seconds at 23° C. After the 60 second immersion, the substrates were removed from the treatment solutions and hung vertically for 10 minutes to allow for excess liquid to drip off the substrates.

Drying/Curing Procedure

After air drying at 23° C. for ˜10 minutes following the dip coat procedure, the treated substrates were left to air dry at 23° C. for an additional 24 hours (only method step L4) or were placed in an oven for 30 minutes at 180° C. (method steps L4) and L5).

Neutral Salt Spray Testing Procedure (NSS Test)

Before evaluating the treated metal substrates in a neutral salt spray test, wax was used to coat the edges of the metal substrates. The treated metal substrates were evaluated with a Q-Fog Cyclic Corrosion Tester (The Q-Panel Company) according to ASTM B117 (2019).

The results of the NSS test are summarized in the following table:

TABLE 3
NSS test, aluminum substrates.

| | | Aluminum |
|---|---|---|
| | | 2024T3 |
| | Drying/Curing | 1000 hours in |
| Treatment solution | conditions | the NSS test |
| Anti-corrosion agent 1 | 23° C., 24 hours | almost no rust |
| (inventive) | | |
| Anti-corrosion agent 1 | 180° C., 30 min | no rust |
| (inventive) | | |
| Sol-gel coating 1 (comparative) | 23° C., 24 hours | white rust |
| Sol-gel coating 1 (comparative) | 180° C., 30 min | white rust |
| Sol-gel coating 3 (comparative) | 23° C., 24 hours | flash rust, |
| | | entire surface |
| | | covered |
| Sol-gel coating 4 (comparative) | 23° C., 24 hours | white rust |

When comparing the substrates after 1000 hours in the NSS test, it is obvious that the inventive anti-corrosion agent 1 has a much better anti-corrosion effect on aluminum substrates compared to the prior art solutions. The substrates treated according to the invention showed no or almost no rust formation after the test. Contrary to these findings, the prior art solutions gave almost completely corroded substrates in the NSS test.

TABLE 4
NSS test, cold rolled steel substrates.

| | | Cold rolled | Cold rolled |
|---|---|---|---|
| | | steel | steel |
| Treatment | Drying/Curing | 1 hour in the | 4 hours in the |
| solution | conditions | NSS test | NSS test |
| Anti-corrosion | 23° C., 24 hours | No rust | Very few |
| agent 2 | | | individual red |
| (inventive) | | | rust spots |
| Anti-corrosion | 180° C., 30 min | No rust | No rust |
| agent 2 | | | |
| (inventive) | | | |
| Sol-gel coating 2 | 23° C., 24 hours | Heavy rust | Heavy rust |
| (comparative) | | (>90% of the | (>90% of the |
| | | surface | surface |
| | | covered) | covered) |
| Sol-gel coating 2 | 180° C., 30 min | red rust covering | approx. ⅓ of the |
| (comparative) | | approx. 10% of | substrate covered |
| | | substrate surface | in red rust |

Cold rolled steel substrates treated with the sol-gel coating 3 immediately after the immersion and drying showed flash rust over the entire surface and thus, these substrates were not subjected to the NSS test.

Again, the substrates treated with the inventive anti-corrosion agent gave a much better anti-corrosion effect compared to the comparative coatings which were significantly inferior in this regard.

Alkaline Resistance Testing Procedure

A solution containing 10 weight-% sodium hydroxide (NaOH) and 90 weight-% D water was formulated and stirred for 60 minutes at 23° C. until the sodium hydroxide pellets fully dissolved. After applying and drying/curing the treatment solutions on the aluminum substrates, the substrates were first weighed on three separate scales. The average and standard deviation of these weight measurements were recorded. Following this weighing, the substrates were immersed in said alkaline solution for 10 minutes at 23° C. Following this, the treated metal substrates were rinsed with DI water and dried with a compressed air gun. The substrates were then weighed on three separate scales to investigate any mass loss that occurred dung the test.

TABLE 5
Alkaline Resistance Test Results.

| | Curing conditions | mass loss [%] |
|---|---|---|
| untreated substrate (comparative) | — | 7.6% |
| Anti-corrosion agent 1 (inventive) | 23° C., 24 hours | 3.1 |
| Anti-corrosion agent 1 (inventive) | 180° C., 30 min | 0.3 |
| Sol-gel coating 1 (comparative) | 23° C., 24 hours | 10.3 |
| Sol-gel coating 1 (comparative) | 180° C., 30 min | 13.2 |
| Sol-gel coating 3 (comparative) | 23° C., 24 h | 12.3 |

The aluminum substrates treated either with the comparative solutions or not at all suffered a higher mass loss than those treated with the inventive anti-corrosion agent. Further, they also showed significant gas formation while immersed in the alkaline solution. The gas is most probably hydrogen liberated from the water due to a reaction with the aluminum surface. Contrary to that, no gas formation was observed in case of the inventively treated substrates. In summary, the state-of-the art substrates were much more susceptible to alkaline corrosion than the substrates treated according to the invention.

Water Immersion Testing Procedure

The untreated and cold rolled steel substrates treated with the treatment solutions were immersed in DI water for seven days in an oven held at 50° C. Following this seven day immersion period, the cold rolled steel substrates were removed from the solution and observed for any signs of corrosion.

TABLE 6
Water Immersion Test Results.

| | Curing conditions | Cold rolled steel |
|---|---|---|
| untreated substrate | — | Heavy rust (>90% of the |
| | | surface covered) |
| Anti-corrosion agent 2 | 23° C., 24 hours | Pitting corrosion |
| (inventive) | | |
| Anti-corrosion agent 2 | 180° C., 30 min | Pitting corrosion |
| (inventive) | | |
| Sol-gel coating 2 | 23° C., 24 hours | Heavy rust (>90% of the |
| (comparative) | | surface covered) |
| Sol-gel coating 2 | 180° C., 30 min | Heavy rust (>90% of the |
| (comparative) | | surface covered) |

After immersing the uncoated and treated cold rolled steel substrates in DI water for seven days in an oven held at 50° C., different forms of corrosion were observed. The uncoated cold rolled steel and cold rolled steel treated with sol-gel coating 2 (either dried at 23° C. or cured at 180° C.) showed significant signs of general surface corrosion and a higher corrosion coverage, while the cold rolled steel treated according to the invention (either dried at 23° C. or cured at 180° C.) showed little general surface corrosion, lower corrosion coverage, and visible signs of pitting corrosion. It is important to note that pitting corrosion occurred on all of the uncoated and treated cold rolled steel panels during this water immersion test and was the first sign of corrosion for all the substrates as well.

Electrochemical Impedance Spectroscopy Testing Procedure

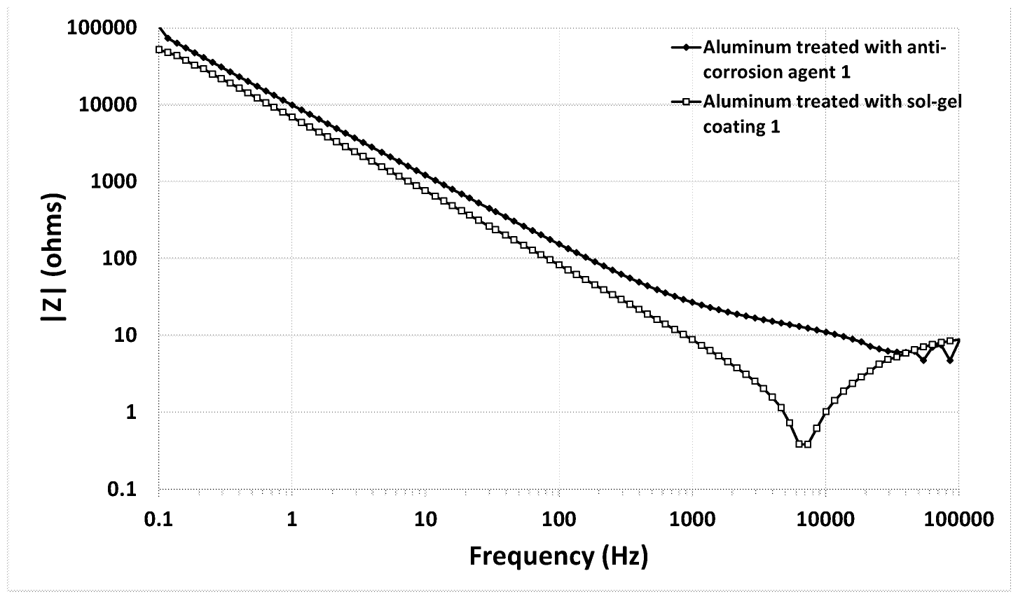

Electrochemical Impedance Spectroscopy (EIS) testing was performed by Matergenics Incorporated. Gamry PCI4/750 potentiostats were used to record the impedance spectra at frequencies of 0.1 cycles/second-100,000 cycles/second. The treated metal substrates were immersed in an aqueous conductive 3.5 weight-% NaCl solution during testing. All tests were performed in a grounded Faraday cage at room temperature. The impedance measurements in this test were carried out over a frequency range of 0.1 Hz to 100,000 Hz, as represented in the Bode plot (FIG. 1).

TABLE 7
Electrochemical Impedance Spectroscopy Test Results.

| | | Impedance |
|---|---|---|
| | | magnitude |
| | Curing conditions | [kΩ] |
| Anti-corrosion agent 1 | 23° C., 24 hours | 69 |
| (inventive) | | |
| Anti-corrosion agent 1 | 180° C., 30 min | 103 |
| (inventive) | | |
| Sol-gel coating 1 | 180° C., 30 min | 55 |
| (comparative) | | |
| Sol-gel coating 3 | 23° C., 24 hours | 51 |
| (comparative) | | |

The impedance magnitude of the anti-corrosion layers is always higher compared to those layers obtained from the prior art. This is another indication that the present invention allows for enhanced anti-corrosion effects compared to the prior art.

Application of Primer Layers

Two different primer layers were employed:
1. Chrome Hazard Free Epoxy Flexible Primer CM0483790 (provided by Sherwin Williams)—2K solvent-borne epoxy aerospace primer (hereinafter referred to as solvent-borne epoxy primer)
2. Water Reducible High Performance Epoxy Primer 44GN098 (provided by PPG Aerospace)—2K waterborne epoxy aerospace primer (hereinafter referred to as water-borne epoxy primer)

The first primer provided by Sherwin Williams primer is a solvent-borne epoxy primer, the latter primer provided by PPG Aerospace is water-borne epoxy primer. The primer layers were formed directly on the treated metal substrates described hereinbefore. For example, the primer layers were each placed on a substrate having an inventive anti-corrosion layer and a comparative sol-gel-coating, respectively.

To prepare the water-borne epoxy primer, the entire catalyst component (126 mL) was mixed into the base component (251 mL) and DI water was added (588 mL) followed by a paint shaking for 5 minutes. This paint was filtered using a paint strainer before use. The pot life of this paint was approximately 4 hours. All of these preparation instructions were done following the instructions on the TDS/paint can.

To prepare the solvent-borne epoxy primer, the entire adduct (200 mL) and reducer (200 mL—the reducer was acetone) was added into the base component (600 mL) and shaken in a paint shaker for 15 minutes. This paint was filtered using a paint strainer before use. The pot life of this paint was approximately 3 hours. All of these preparation instructions were done following the instructions on the TDS/paint can.

Both primer layers were applied via spraying with an HVLP spray gun (Jaguar SLP) on substrates formed as described hereinbefore. The tip size was 1.3 mm, the pot and tip pressure were 10 psi, the temperature was 68° C., and the relative humidity was 40% during this spray application. Dry film thicknesses for all the primed substrates were approximately 1.0-1.2 mils (approximately 25.4 to 30.5 μm). The substrates were cured for a minimum of 14 days at room temperature and ˜40% relative humidity before proceeding with any performance evaluations.

The results of the corrosion tests are given in the subsequent tables. The data listed in left columns refers to the layer formed on the substrate surface itself (if any) and whereupon the primer layer is placed.

TABLE 8
Neutral salt spray test results of aluminum substrates (Aluminum
2024T3) with water- borne epoxy primer layers.

| | | water-borne | water-borne |
|---|---|---|---|
| | | epoxy primer | epoxy primer |
| | | on AI2024T3 | on AI2024T3 |
| Treatment | Drying/Curing | 275 hours in | 1000 hours in |
| solution | conditions | the NSS test | the NSS test |
| No treatment | — | minor blistering | white rust and |
| solution | | | blistering |
| Anti-corrosion | 23° C., 24 hours | minor blistering | heavy blistering |
| agent 1 (inventive) | | | |
| Anti-corrosion | 180° C., 30 min | minor blistering | heavy blistering |
| agent 1 (inventive) | | | |
| Sol-gel coating 1 | 180° C., 30 min | approx. 1/3 of the | approx. ⅔ of the |
| (comparative) | | substrate covered in | substrate covered in |
| | | white rust | white rust |
| Sol-gel coating 3 | 23° C., 24 hours | approx. 50% of the | approx. ⅔ of the |
| (comparative) | | substrate covered in | substrate covered in |
| | | pitting corrosion | pitting corrosion |

The inventive aluminum substrates comprising an anti-corrosion layer and a primer layer showed better results than those of the prior art with the sol-gel coatings.

TABLE 9
Neutral salt spray test results of aluminum substrates (Aluminum
2024T3) with solvent-borne epoxy primer layers.

| | | Solvent-borne epoxy | Solvent-borne epoxy |
|---|---|---|---|
| | | primer on AI2024T3 | primer on AI2024T3 |
| Treatment | Drying 1 Curing | 275 hours in the | 1000 hours in the |
| solution | conditions | NSS test | NSS test |
| No treatment | — | no rust | approx. 1/3 of the |
| solution | | | substrate covered in |
| | | | white rust and |
| | | | blistering |
| Anti-corrosion | 23° C., 24 hours | no rust | blistering |
| agent 1 (inventive) | | | |
| Anti-corrosion | 180° C., 30 min | no rust | blistering |
| agent 1 (inventive) | | | |
| Sol-gel coating 1 | 180° C., 30 min | minor blistering | approx. ¼ of the |
| (comparative) | | | substrate covered in white rust and |
| | | | blistering |
| Sol-gel coating 3 | 23° C., 24 hours | no rust | approx. ⅓ of the |
| (comparative) | | | substrate covered in |
| | | | pitting corrosion |

The inventive aluminum substrates comprising an anti-corrosion layer and a primer layer showed better results than those of the prior art. When comparing the substrates obtained by applying the water-borne and the solvent-borne primer layers, it is obvious that the latter were even more corrosion-resistant.

TABLE 10
Neutral salt spray test results of steel substrates (cold
rolled steel) with solvent-borne epoxy primer layers.

| | | Solvent-borne | Solvent-borne |
|---|---|---|---|
| | | epoxy primer on | epoxy primer on |
| | | cold rolled steel | cold rolled steel |
| Treatment | Drying/Curing | 24 hours in the | 350 hours in the |
| solution | conditions | NSS test | NSS test |
| No treatment | — | heavy rust (>90% of | heavy rust (>90% of |
| solution | | the surface covered) | the surface covered) |
| Anti-corrosion agent 2 | 23° C., 24 hours | very few individual | very few individual |
| (inventive) | | red rust spots and | red rust spots and |
| | | blistering | blistering |
| Anti-corrosion agent 2 | 180° C., 30 min | approx. ⅓ of the | approx. ⅓ of the |
| (inventive) | | substrate covered in | substrate covered in |
| | | red rust | red rust |
| Sol-gel coating 2 | 180° C., 30 min | many individual red | heavy rust (>90% of |
| (comparative) | | rust spots and | the surface covered) |
| | | blistering | and blistering |

TABLE 11
Neutral salt spray test results of steel substrates (cold
rolled steel) with water-borne epoxy primer layers.

| | | Water-borne epoxy primer | Water-borne epoxy primer |
|---|---|---|---|
| | | on cold rolled steel | on cold rolled steel |
| Treatment | Drying/Curing | 24 hours in the | 350 hours in the |
| solution | conditions | NSS test | NSS test |
| No treatment solution | — | many individual red | heavy rust (>90% of the |
| | | rust spots and blistering | surface covered) and |
| | | | blistering |
| Anti-corrosion agent 2 | 23° C., 24 hours | no rust | very few individual red |
| (inventive) | | | rust spots and blistering |
| Anti-corrosion agent 2 | 180° C., 30 min | very few individual | heavy rust (>90% of the |
| (inventive) | | red rust spots and | surface covered) and |
| | | blistering | blistering |
| Sol-gel coating 2 | 180° C., 30 min | no rust | approx. ⅓ of the substrate |
| (comparative) | | | covered in red rust |

The results of the steel substrates with the primer on the inventive coatings were again superior compared to the prior art results. Interestingly, the inventive substrates obtained with 23° C. curing performed better in terms of corrosion resistance than those cured at elevated temperatures.

Humidity Tests

The substrates comprising the primer layer were placed in a humidity chamber (humidity chamber purchased from Associated Environmental Systems, Inc.) for 168 hours at a relative humidity of 95% and a temperature of 35° C. prior to optical inspection. The results are given in the subsequent tables.

TABLE 12
Humidity test results of aluminum substrates.

| | | Aluminum 2024T3 |
|---|---|---|
| | | 168 hours in |
| | | humidity chamber |
| Treatment | Drying/Curing | at 35 C. and 95% |
| solution | conditions | relative humidity |
| No treatment | — | white rust |
| solution | | |
| Anti-corrosion agent 1 | 23° C., 24 hours | no rust |
| (inventive) | | |
| Anti-corrosion agent 1 | 180° C., 30 min | no rust |
| (inventive) | | |
| Sol-gel coating 1 | 180° C., 30 min | almost no rust |
| (comparative) | | |
| Sol-gel coating 3 | 23° C., 24 hours | no rust |
| (comparative) | | |

TABLE 13
Humidity test results of cold rolled steel substrates.

| | | Cold Rolled Steel |
|---|---|---|
| | | 168 hours in |
| | | humidity chamber |
| Treatment | Drying/Curing | at 35 C. and 95% |
| solution | conditions | relative humidity |
| No treatment | — | approx. ¼ of the |
| solution | | substrate covered in red |
| | | rust |
| Anti-corrosion agent 2 | 23° C., 24 hours | very few individual red |
| (inventive) | | rust spots |
| Anti-corrosion agent 2 | 180° C., 30 min | heavy rust (>90% of the |
| (inventive) | | surface covered) |
| Sol-gel coating 2 | 180° C., 30 min | heavy rust (>90% of the |
| (comparative) | | surface covered) |

The results of the inventive substrates allowed for improved results compared to the prior art. It should be stressed that the inventive low-curing example on cold rolled steel was better than the prior art and the example using higher curing temperatures.

Post Salt Spray Adhesion Test—Results Chart (Cold Rolled Steel with a Solvent-Borne Epoxy Primer Layer) Run According to ASTM D 3359-02

Substrates (both steel and aluminum) were submitted to the NSS test and then to an adhesion test according to ASTM B 117-19. The test results are provided in the following tables.

TABLE 14
Adhesion Test Results of cold rolled steel substrates
with a solvent-borne epoxy primer layer.

| | | Solvent-borne epoxy |
|---|---|---|
| | | primer on cold rolled |
| | | steel |
| No treatment | Drying/Curing | After 350 hours in the |
| solution | conditions | NSS test |
| No pretreatment | — | 1B (40% adhesion loss) |
| Anti-corrosion agent 2 | 23° C., 24 hours | 3B (10% adhesion loss) |
| (inventive) | | |
| Anti-corrosion agent 2 | 180° C., 30 min | 2B (20% adhesion loss) |
| (inventive) | | |
| Sol-gel coating 2 | 180° C., 30 min | 0B (100% adhesion loss) |
| (comparative) | | |

TABLE 15
Adhesion Test Results of cold rolled steel substrates
with a water-borne epoxy primer layer.

| | | Water-borne epoxy |
|---|---|---|
| | | primer on cold |
| | | rolled steel |
| Treatment | Drying/Curing | After 350 hours in |
| solution | conditions | the NSS test |
| No treatment solution | — | 2B (30% adhesion loss) |
| Anti-corrosion agent 2 | 23° C., 24 hours | 3B (10% adhesion loss) |
| (inventive) | | |
| Anti-corrosion agent 2 | 180° C., 30 min | 3B (10% adhesion loss) |
| (inventive) | | |
| Sol-gel coating 2 | 180° C., 30 min | 0B (100% adhesion loss) |
| (comparative) | | |

The adhesion of the layers on the substrates of the inventive examples were much better compared to the substrates without coating layer between the substrate surface (no pretreatment) and the comparative substrates with the sol-gel coatings. While the comparative sol-gel coatings performed even inferior to those substrates without any coating, the inventive substrates showed only little adhesion losses in the test. And like in the tests described hereinbefore, the anti-corrosion layer cured at 23° C. outperformed its counterpart cured at elevated temperatures (in case of the solvent-borne epoxy primer).

Other embodiments of the present invention will be apparent to those skilled in the art from a consideration of this specification or practice of the invention disclosed herein. It is intended that the specification and examples be considered as exemplary only, with the true scope of the invention being defined by the following claims only.

1-15. (canceled)

16: A kit-of-parts for preparing an anti-corrosion agent, comprising:
A) at least one silica sol based composition comprising at least a reaction product of at least the following components:
at least one glycidyloxypropylalkoxysilane;
at least one aqueous silica sol;
at least one organic acid; and
at least one metal compound, wherein a metal of the at least one metal compound is a member of group 4 of the periodic table of elements according to IUPAC nomenclature; and
B) at least one aminoalkyl functional siloxane compound;
wherein the at least one aminoalkyl functional siloxane compound comprises:
at least one molecular unit according to formula (B1) 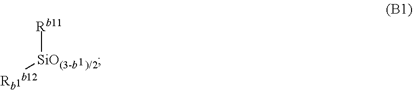
wherein
R^{b11} is a C₁-C₁₈-alkyl group;
each R^{b12} is independently an oxyalkyl group;
b¹ is 0, 1 or 2; and
at least one molecular unit according to formula (B2) 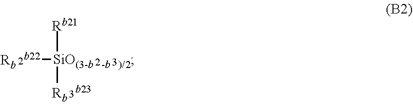
wherein
R^{b21} is an aminoalkyl functional group;
R^{b22} is C₁-C₈-alkyl group;
each R^{b23} is independently an oxyalkyl group;
b² is 0 or 1; and
b³ is 0, 1 or 2;
with the proviso that a sum of b² and b³ is 0, 1 or 2.

17: The kit-of-parts according to claim 16,
wherein R^{b21} is a 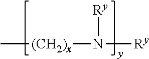
group
wherein
each x is independently an integer ranging from 1 to 6;
y is an integer from 1, 2 or 3; and
each R^{y} is independently selected from the group consisting of hydrogen, alkyl group, and aryl group.

18: The kit-of-parts according to claim 16, wherein the at least one aminoalkyl functional siloxane compound is a block-oligomer or a block-polymer.

19: The kit-of-parts according to claim 16, wherein the at least one aminoalkyl functional siloxane compound has an alkoxy group content ranging from 0.1 to 50 weight-%, based on the at least one aminoalkyl functional siloxane compound.

20: The kit-of-parts according to claim 16, wherein R^{b11} is a C₂-C₈-alkyl group.

21: The kit-of-parts according to claim 16, wherein b² is 0.

22: The kit-of-parts according to claim 16, wherein the at least one aminoalkyl functional siloxane compound comprises 2 to 30 molecular units according to formulae (B1) and (B2).

23: The kit-of-parts according to claim 16, wherein the at least one silica sol based composition consists of a reaction product of at least the following components:
the at least one glycidyloxypropylalkoxysilane;
the at least one aqueous silica sol;
the at least one organic acid;
the at least one metal compound, wherein a metal of the at least one metal compound is a member of group 4 of the periodic table of elements according to IUPAC nomenclature;
water;
optionally, at least one organic solvent; and
optionally, at least one surfactant.

24: The kit-of-parts according to claim 16, wherein the at least one aminoalkyl functional siloxane compound has an alkoxy group content ranging from 1 to 30 weight-%, based on the aminoalkyl functional siloxane compound.

25: A method for preparing an anti-corrosion agent, the method comprising:
providing a silica sol based composition comprising at least a reaction product of at least the following components
at least one glycidyloxypropylalkoxysilane;
at least one aqueous silica sol;
at least one organic acid; and
at least one metal compound, wherein a metal of the at least one metal compound is a member of group 4 of the periodic table of elements according to IUPAC nomenclature; and
providing at least one aminoalkyl functional siloxane compound comprising
at least one molecular unit according to formula (B1) 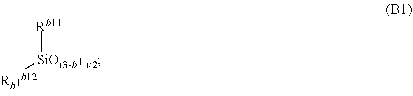
wherein
R^{b11} is a C₁-C₁₈-alkyl group;
each R^{b12} is independently an oxyalkyl group;
b¹ is 0, 1 or 2; and
at least one molecular unit according to formula (B2) 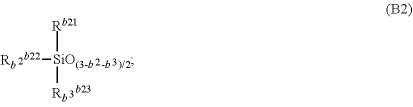
wherein
R^{b21} is an aminoalkyl functional group;
R^{b22} is C₁-C₈-alkyl group;
each R^{b23} is independently an oxyalkyl group;
b² is 0 or 1; and
b³ is 0, 1 or 2;
with the proviso that a sum of b² and b³ is 0, 1 or 2; and
mixing the silica sol based composition and the at least one aminoalkyl functional siloxane compound, such that the anti-corrosion agent is formed.

26: An anti-corrosion agent, obtainable by a reaction of:
A) at least a reaction product of at least the following components
at least one glycidyloxypropylalkoxysilane;
at least one aqueous silica sol;
at least one organic acid; and
at least one metal compound, wherein a metal of the at least one metal compound is a member of group 4 of the periodic table of elements according to IUPAC nomenclature; and
B) at least one aminoalkyl functional siloxane compound comprising
at least one molecular unit according to formula (B1) 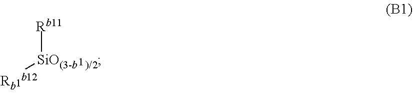
wherein
R^{b11} is a C₁-C₁₈-alkyl group;
each R^{b12} is independently an oxyalkyl group;
b is 0, 1 or 2; and
at least one molecular unit according to formula (B2) 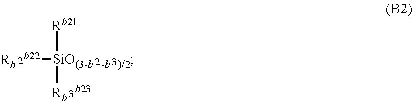
wherein
R^{b21} is an aminoalkyl functional group;
R^{b22} is C₁-C₈-alkyl group;
each R^{b23} is independently an oxyalkyl group;
b² is 0 or 1; and
b³ is 0, 1 or 2;
with the proviso that a sum of b² and b³ is 0, 1 or 2.

27: A method for forming at least one anti-corrosion layer, the method comprising:
providing a substrate having at least one metallic surface;
optionally, pretreating the at least one metallic surface; and
contacting the at least one metallic surface of the substrate with the anti-corrosion agent according to claim 26, such that an anti-corrosion layer is formed on the metallic surface of the substrate.

28: An anti-corrosion layer formed by contacting at least a portion of a metallic surface of a substrate with the anti-corrosion agent according to claim 26.

29: An article, comprising:
a substrate having at least one metallic surface; and
at least one anti-corrosion layer formed by contacting the at least one metallic surface of the substrate with the anti-corrosion agent according to claim 26;
wherein the at least one anti-corrosion layer is located on the at least one metallic layer.

30: The kit-of-parts according to claim 16, wherein in formula (B2), R^{b22} is a C₁-C₄-alkyl group.

31: The kit-of-parts according to claim 16, wherein in formula (B2), R^{b22} is a methyl group or an ethyl group.

32: The kit-of-parts according to claim 17, wherein each R^{Y} is independently hydrogen or a C₁-C₄-alkyl group.

33: The kit-of-parts according to claim 17, wherein each R is hydrogen.

34: The kit-of-parts according to claim 19, wherein the at least one aminoalkyl functional siloxane compound has an alkoxy group content ranging from 3 to 10 weight-%, based on the at least one aminoalkyl functional siloxane compound.

35: The kit-of-parts according to claim 22, wherein the at least one aminoalkyl functional siloxane compound comprises 4 to 15 molecular units according to formulae (B1) and (B2).
